(19) United States
(12) Patent Application Publication
(10) Pub. No.: US 2026/0149340 A1
(43) Pub. Date: May 28, 2026

(54) PIEZOELECTRIC MEASURING DEVICE BY PWM FOR A MOTOR VEHICLE

(71) Applicant: AUMOVIO Germany GmbH, Frankfurt am Main (DE)

(72) Inventors: Thomas Morin, Toulouse (FR); Franck Nieceron, Toulouse (FR); Kahina Telmat, Toulouse (FR)

(73) Assignee: AUMOVIO Germany GmbH, Frankfurt am Main (DE)

(21) Appl. No.: 19/386,449

(22) Filed: Nov. 12, 2025

(30) Foreign Application Priority Data
Nov. 22, 2024 (FR) FR2412832

(51) Int. Cl. H02K 11/25; G01K 1/024; H01M 10/48; H02K 7/00; H02K 11/00; H04B 11/00

(52) U.S. Cl. CPC H02K 11/25; G01K 1/024; H01M 10/486; H02K 7/006; H02K 11/0094; H04B 11/00; H01M 2220/20

(57) ABSTRACT

A device for measuring a parameter for a motor vehicle, including a main module and a remote module including a sensitive element configured to measure the parameter and a measurement stage configured to generate a pulse-width modulation signal the duty cycle of which is representative of the at least one value of the measured parameter.

### CROSS REFERENCE TO RELATED APPLICATIONS

This application claims priority to French Application No. 2412832, filed Nov. 22, 2024, the contents of such application being incorporated by reference herein.

### FIELD OF THE INVENTION

The present invention relates to the automotive field and more particularly relates2 to a piezoelectric measuring device by PWM for a motor vehicle and to a method for implementing same.

### BACKGROUND OF THE INVENTION

As known, an electric motor comprises a rotor and a stator. Operation of such a motor causes heating of the rotor and stator. However, the rise in temperature of the rotor may cause a loss of performance and demagnetization of the magnets placed inside above a certain temperature, this potentially leading to damage to or even failure of the motor. It is therefore necessary to measure the temperature inside the rotor, so as to be able to reduce the speed thereof when the temperature approaches the critical operating limit and thus avoid damage to or else failure of the motor.

The temperature of the rotor is difficult to measure directly using wired temperature sensors because the rotor rotates during operation, and the temperature is therefore estimated using algorithms and models integrated into the management system of the motor.

However, these integrated algorithms and models lead to measurement errors potentially reaching plus or minus 20° C., this being unsatisfactory for controlling the motor in order to prevent it from being damaged or failing.

A simple, reliable and efficient solution for at least partly overcoming these disadvantages therefore would be advantageous.

### SUMMARY OF THE INVENTION

To this end, an aspect of the invention is firstly a device for measuring a parameter for a motor vehicle, said device comprising a main module and a remote module, said main module comprising a control stage and a main piezoelectric transceiver configured to transmit an ultrasonic supply signal, said control stage being configured to electrically power said main piezoelectric transceiver and to command the transmission of an ultrasonic supply signal by said main piezoelectric transceiver, said remote module comprising a remote piezoelectric transceiver configured to receive the ultrasonic supply signal transmitted by the main piezoelectric transceiver, a sensitive element configured to measure said parameter and generate a measurement signal comprising at least one value of said parameter, and a measurement stage, connected on the one hand to the remote piezoelectric transceiver and on the other hand to said sensitive element and being configured to collect and store the energy of the ultrasonic supply signal received by the remote piezoelectric transceiver, to electrically power the sensitive element using said stored energy, to receive the measurement signal generated by the sensitive element, to extract from said received measurement signal the at least one value of the measured parameter, to generate a pulse-width modulation signal the duty cycle of which is representative of the at least one value of the extracted measured parameter, the remote piezoelectric transceiver being configured to convert the received pulse-width modulation signal into an ultrasonic measurement signal and to transmit said ultrasonic measurement signal to the main piezoelectric transceiver, the control stage being configured to determine the duty cycle of the ultrasonic measurement signal received by the main piezoelectric transceiver, the duty cycle of which is identical to the duty cycle of the pulse-width modulation signal in order to determine the at least one value of the measured parameter.

The device according to an aspect of the invention allows remote measurements to be taken via the remote module, by powering the sensitive measuring element using the energy of signals sent by the main module over a wireless link. Thus, the measurements may be taken as close as possible to the magnets, this increasing the performance of the control of the electric machine. An aspect of the invention also makes it possible to dispense with metal barriers such as, for example, the casing and the protective flanges, which block electromagnetic waves of Wi-Fi or Bluetooth type.

In one embodiment, the main piezoelectric transceiver and the remote piezoelectric transceiver being configured to resonate at at least one given predetermined frequency, the control stage is configured to generate a signal at said at least one predetermined frequency and to deliver the generated signal to the main piezoelectric transceiver and the measurement stage is configured to generate a signal at said at least one predetermined frequency and to deliver the generated signal to the remote piezoelectric transceiver. The resonance makes it possible to optimize the rate of transmission of the ultrasonic signals and the consumption of current between the transmitter and the receiver.

Alternatively or in addition, the remote module comprising an external communication stage, the measurement stage is configured to command the transmission of signals containing the measured values via said external communication stage. The measured values may thus be sent to an entity outside the measurement device for processing.

The external communication stage may, for example, transmit using a communication protocol of Bluetooth or RFID type.

Advantageously, the control stage comprises a memory area in which is stored a table that is predetermined, for example empirically, and that contains the correspondence between the duty cycle and a range of values of the parameter.

An aspect of the invention also relates to an electric machine for a motor vehicle, said electric machine comprising a stator, a rotor, and a measuring device as described above, said electric machine being configured to be mounted in said vehicle in order to drive the wheels of said vehicle to rotate, in which electric machine the main module is mounted on the stator and the remote module is mounted on the rotor.

Advantageously, the remote module is mounted inside the rotor.

In one embodiment, the rotor comprising a shaft comprising a first shaft portion and a second shaft portion that are mounted on the stator via a system of bearings, the first shaft portion comprising an end face extending orthogonally to the longitudinal axis of rotation of the rotor, the remote piezoelectric transceiver is mounted on said end face and the main piezoelectric transceiver is mounted on a portion of the stator facing said remote piezoelectric transceiver.

An aspect of the invention also relates to a battery for a motor vehicle, comprising a measuring device as described above, the remote module being mounted such that the sensitive element is placed inside said battery.

An aspect of the invention also relates to a battery pack for a motor vehicle, comprising a measuring device as described above, comprising at least one remote module mounted such that the sensitive element is placed inside at least one of the batteries of the battery pack.

An aspect of the invention also relates to a fuel cell for a motor vehicle, comprising a measuring device as described above, the remote module being mounted such that the sensitive element is placed inside said fuel cell.

An aspect of the invention also relates to a motor vehicle comprising a measuring device as described above.

In one embodiment, the vehicle is an electric or hybrid electric vehicle and comprises an electric machine as described above.

In one embodiment, the vehicle comprises a battery or a battery pack or a fuel cell as described above.

An aspect of the invention also relates to a method for measuring a parameter in a motor vehicle using a measuring device as described above, said method comprising the steps of:
commanding, by means of the control stage, the transmission of an ultrasonic supply signal by the main piezoelectric transceiver,
transmitting, by means of the main piezoelectric transceiver, said ultrasonic supply signal,
receiving, by means of the remote piezoelectric transceiver, the transmitted ultrasonic supply signal,
collecting and storing, by means of the measurement stage, the energy of the ultrasonic supply signal,
electrically powering, by means of the measurement stage, the sensitive element, using the stored energy,
measuring, by means of the sensitive element, the parameter,
generating, by means of the sensitive element, a measurement signal comprising at least one value of the measured parameter,
transmitting, by means of the sensitive element, said generated measurement signal to the measurement stage,
receiving, by means of the measurement stage, the measurement signal,
extracting, by means of the measurement stage, at least one value of the measured parameter contained in the received measurement signal,
generating, by means of the measurement stage, a pulse-width modulation signal the duty cycle of which is representative of the at least one value of the extracted measured parameter,
converting, by means of the remote piezoelectric transceiver, the received pulse-width modulation signal into an ultrasonic measurement signal,
transmitting, by means of the remote piezoelectric transceiver, said ultrasonic measurement signal to the main piezoelectric transceiver,
determining, by means of the control stage, the duty cycle of the received ultrasonic measurement signal,
determining, by means of the control stage, the at least one value of the measured parameter on the basis of the determined duty cycle.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates, in a functional manner, a first embodiment of the measuring device according to the invention.

FIG. 2 schematically illustrates, in a functional manner, a second embodiment of the measuring device according to the invention.

FIG. 3 schematically illustrates one example of an electric machine according to an aspect of the invention.

FIG. 4 schematically illustrates one example of a battery according to an aspect of the invention.

FIG. 5 schematically illustrates one example of a battery pack according to an aspect of the invention.

FIG. 6 schematically illustrates one example of a fuel cell according to an aspect of the invention.

FIG. 7 schematically illustrates one embodiment of the method according to the invention.

### DETAILED DESCRIPTION OF EXEMPLARY EMBODIMENTS

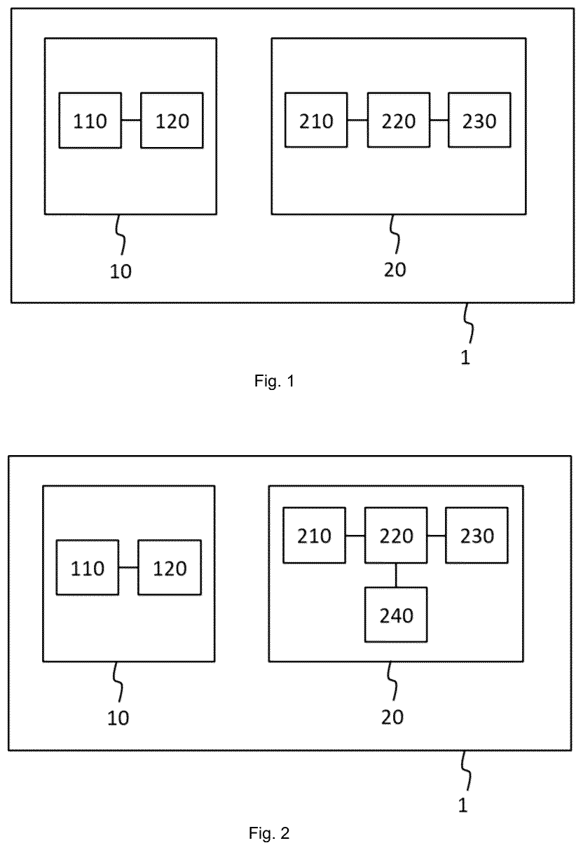

FIG. 1 is one example of a measuring device 1 according to an aspect of the invention. The device 1 is intended to be mounted in a motor vehicle.

The device 1 comprises a main module 10 and a remote module 20.

### Main Module 10

The main module 10 comprises a control stage 110 and a main piezoelectric transceiver 120.

The control stage 110 is configured to electrically power said main piezoelectric transceiver 120 and to command the transmission of ultrasonic signals by said main piezoelectric transceiver 120, preferably at a resonant frequency of said main piezoelectric transceiver 120.

The main piezoelectric transceiver 120 is configured to transmit and receive ultrasonic signals, called “supply” signals SUA, so as to electrically power the remote module 20.

Preferably, the main piezoelectric transceiver 120 is configured to resonate at at least one predetermined frequency, and preferably at two predetermined frequencies, 200 kHz and 2 MHz for example.

### Remote Module 20

The remote module 20 comprises a remote piezoelectric transceiver 210, a measurement stage 220 and a sensitive element 230.

The remote piezoelectric transceiver 210 is configured to receive ultrasonic supply signals SUA transmitted by the main piezoelectric transceiver 120 and transmit them to the measurement stage 220.

Preferably, the remote piezoelectric transceiver 210 is configured to resonate at at least one predetermined frequency, and preferably at two predetermined frequencies, 200 kHz and 2 MHz for example.

The measurement stage 220 is connected on the one hand to the remote piezoelectric transceiver 210 and on the other hand to the sensitive element 230.

The measurement stage 220 is configured to collect and store the energy of the ultrasonic supply signal SUA transmitted by the remote piezoelectric transceiver 210 and to electrically power the sensitive element 230 using said stored energy.

The sensitive element 230 is configured to measure a parameter, for example air temperature, air pressure, degree of humidity, intensity of an electric current, a mechanical force (stress), a torque, etc.

It should be noted that the remote module 20 may comprise more than one sensitive element 230 in order to measure a plurality of different parameters and/or a plurality of identical parameters at various locations.

The sensitive element 230 is configured to generate a measurement signal S comprising one or more values of said parameter.

The measuring stage 220 is configured to receive the measurement signal S generated by the sensitive element 230, to extract from said received measurement signal S the at least one value of the measured parameter and to generate a pulse-width modulation PWM signal the duty cycle of which is representative of the at least one value of the extracted measured parameter.

The remote piezoelectric transceiver 210 is configured to convert the received pulse-width modulation PWM signal into an ultrasonic measurement signal SUM and to transmit said ultrasonic measurement signal SUM to the main piezoelectric transceiver 120.

The control stage 110 is configured to determine the duty cycle of the ultrasonic measurement signal SUM received by the main piezoelectric transceiver 120, this duty cycle being identical to the duty cycle of the pulse-width modulation PWM signal, and to determine the at least one value of the measured parameter on the basis of said determined duty cycle.

The one or more parameter value may be determined on the basis of the duty cycle by using a correspondence table stored in a memory area of the control stage 110. Such a table may have been determined empirically beforehand.

In another embodiment, illustrated in FIG. 2, the remote module 20 comprising an external communication stage 240, the measurement stage 220 is configured to command the transmission of signals containing the measured parameter values (extracted from the measurement signal S) via said external communication stage 240, in particular to an entity outside the device 1. This transmission may for example be carried out over a communication interface of Bluetooth, Wifi, 5G or RFID type, which are known per se. In this case, the external communication stage 240 preferably comprises a microcontroller allowing this transmission function to be performed.

### EXAMPLES OF USE OF THE MEASURING DEVICE ACCORDING TO AN ASPECT OF THE INVENTION

### Example 1: Electric Machine 300

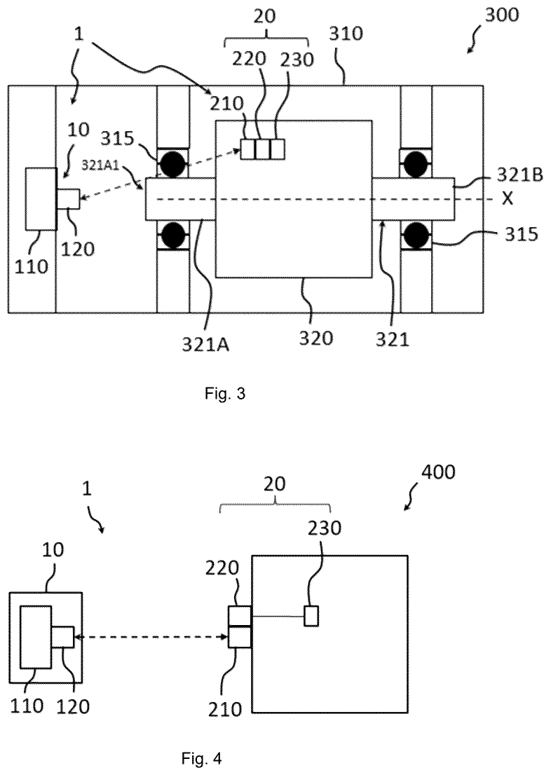

FIG. 3 shows one example of an electric machine 300 for a motor vehicle. The electric machine 300 is configured to be mounted in the vehicle in order to drive the wheels of said vehicle to rotate.

The electric machine 300 comprises a stator 310, a rotor 320, and a device 1 as described above.

The main module 10 is mounted on the stator 310 and the remote module 20 is mounted on the rotor 320.

The rotor 320 is configured to rotate about a longitudinal axis X.

In this example, the rotor 320 comprises an integral shaft 321 extending along the longitudinal axis X of rotation and comprising a first shaft portion 321A and a second shaft portion 321B that are connected to the stator 310 via a system of bearings 315.

The first shaft portion 321A comprises an end face 321A1 extending orthogonally to the longitudinal axis X of rotation of the rotor 320. The remote piezoelectric transceiver 210, the measurement stage 220 and the sensitive element are mounted inside the rotor 320 and the main piezoelectric transceiver 120 is mounted on a portion of the stator 310 facing said end face 321A1.

### Example 2: Battery 400

FIG. 4 is an example of a battery 400 for a motor vehicle.

The main module 10 is placed away from the battery 400 while the remote module 20 is mounted on the battery 400 such that the sensitive element 230 measures a parameter inside said battery 400, for example temperature or pressure, degree of humidity, intensity of an electric current, a mechanical force (stress), a torque, or other.

It should be noted that the remote piezoelectric transceiver 210 and the measurement stage 220 may be mounted on an external face of the battery 400 or inside the battery 400 with the sensitive element 230, as in example 1 of an electric machine 300.

### Example 3: Battery Pack 500

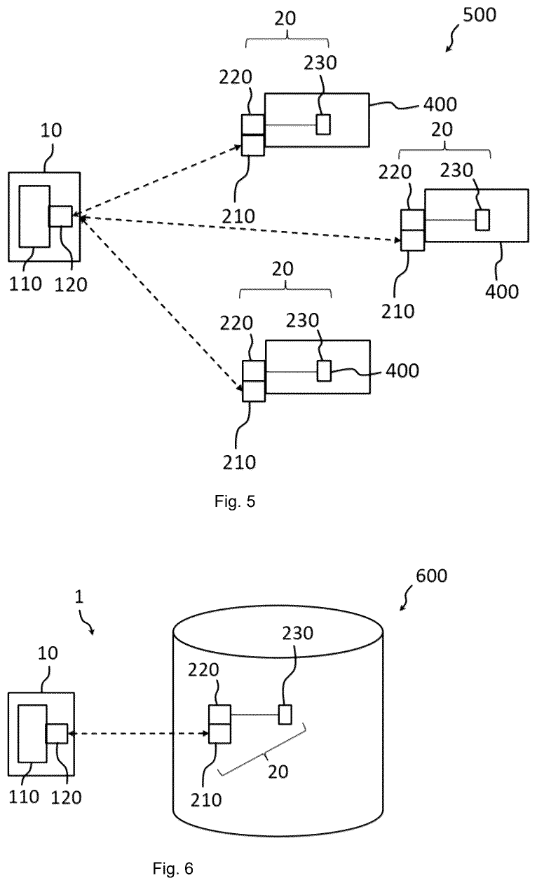

FIG. 5 is an example of a battery pack 500 for a motor vehicle.

The main module 10 is placed away from the battery pack 500 while one or more remote modules 20 are respectively mounted on one or more of the batteries 400 of the battery pack 500 such that the sensitive element 230 of each remote module 20 measures a parameter inside of each battery 400, for example temperature or pressure or other.

### Example 4: Fuel Cell 600

FIG. 6 is an example of a fuel cell 600 for a motor vehicle.

The main module 10 is placed away from the fuel cell 600 while the remote module 20 is mounted on the fuel cell 600 such that the sensitive element 230 measures a parameter inside said fuel cell 600, for example in the circuit for supplying air to the membranes of the fuel cell 600. Once again, the one or more measured parameters may for example be temperature, pressure, degree of humidity, intensity of an electric current, a mechanical force (stress) or a torque.

### Example of Implementation

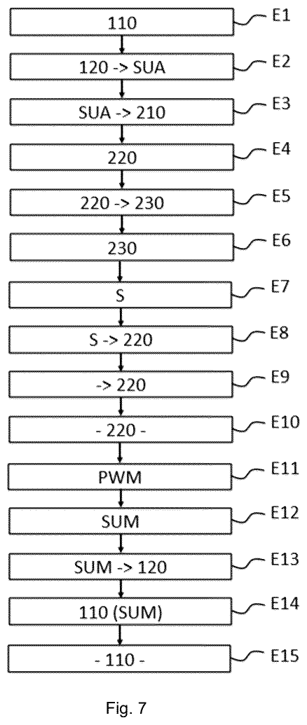

One example of implementation of the device 1 will now be described with reference to FIG. 7. In this non-limiting example, the parameter to be measured may for example be temperature, in particular inside a rotor 320 of an electric machine 300.

Firstly, when it is necessary to measure the parameter, the control stage 110 of the main module 10 commands, in a step E1, the transmission of an ultrasonic supply signal SUA by the main piezoelectric transceiver 120, preferably at one of the resonant frequencies to improve the quality of transmission of said ultrasonic supply signal SUA.

In a step E2, the main piezoelectric transceiver 120 transmits the ultrasonic supply signal SUA, which is received by the remote piezoelectric transceiver 210 in a step E3 and transmitted to the measurement stage 220.

In a step E4, the measurement stage 220 collects and stores the energy of the ultrasonic supply signal SUA, then electrically powers the sensitive element 230 using the stored energy in a step E5.

Once electrically powered, the sensitive element 230 measures, in a step E6, the parameter of interest, which may for example be air temperature, air pressure, degree of humidity, intensity of an electric current, a mechanical force (stress) or a torque.

During the measurement of the parameter, the sensitive element 230 generates, in a step E7, a measurement signal S comprising one or more values of the measured parameter, then transmits, in a step E8, the generated measurement signal S to the measurement stage 220.

The measurement stage 220 receives the transmitted measurement signal S in a step E9, then extracts the one or more values of the measured parameter contained in the received measurement signal S in a step E10.

The measurement stage 220 then generates, in a step E11, a pulse-width modulation PWM signal the duty cycle of which is representative of the at least one value of the extracted measured parameter. In particular, when a plurality of different values are measured, the duty cycle varies as a function of said values. By way of example, a duty cycle of 25% may correspond to a temperature of 30° C., a duty cycle of 50% may correspond to a temperature of 50° C., a duty cycle of 75% may correspond to a temperature of 70° C.

The remote piezoelectric transceiver 210 then converts, in a step E12, the received pulse-width modulation PWM signal into an ultrasonic measurement signal SUM which is transmitted by the remote piezoelectric transceiver 210 to the main piezoelectric transceiver 120 in a step E13.

The ultrasonic measurement signal SUM is received and transmitted by the main piezoelectric transceiver 120 to the control stage 110 which determines the duty cycle of the received ultrasonic measurement signal SUM in a step E14.

Finally, in a step E15, the control stage 110 determines the at least one value of the measured parameter on the basis of the determined duty cycle, for example on the basis of the predetermined correspondence table stored in its memory area.

The invention therefore makes it possible to measure a parameter using a remote module 20 that is supplied with electrical energy remotely, thus avoiding the use of a replaceable battery, something that is particularly advantageous in the case of a rotor of an electric machine.

1. A device for measuring a parameter for a motor vehicle, said device comprising a main module and a remote module, said main module comprising a control stage and a main piezoelectric transceiver configured to transmit an ultrasonic supply signal, said control stage being configured to electrically power said main piezoelectric transceiver and to command the transmission of an ultrasonic supply signal by said main piezoelectric transceiver, said remote module comprising a remote piezoelectric transceiver configured to receive the ultrasonic supply signal transmitted by the main piezoelectric transceiver, a sensitive element configured to measure said parameter and generate a measurement signal comprising at least one value of said parameter, and a measurement stage, connected on the one hand to the remote piezoelectric transceiver and on the other hand to said sensitive element and being configured to collect and store the energy of the ultrasonic supply signal received by the remote piezoelectric transceiver, to electrically power the sensitive element using said stored energy, to receive the measurement signal generated by the sensitive element, to extract from said received measurement signal the at least one value of the measured parameter, to generate a pulse-width modulation signal the duty cycle of which is representative of the at least one value of the extracted measured parameter, the remote piezoelectric transceiver being configured to convert the received pulse-width modulation signal into an ultrasonic measurement signal and to transmit said ultrasonic measurement signal to the main piezoelectric transceiver, the control stage being configured to determine the duty cycle of the ultrasonic measurement signal received by the main piezoelectric transceiver, the duty cycle of which is identical to the duty cycle of the pulse-width modulation signal in order to determine the at least one value of the measured parameter.

2. The device as claimed in claim 1, wherein, the main piezoelectric transceiver and the remote piezoelectric transceiver being configured to resonate at at least one given predetermined frequency, the control stage is configured to generate a signal at said at least one predetermined frequency and to deliver the generated signal to the main piezoelectric transceiver and the measurement stage is configured to generate a signal at said at least one predetermined frequency and to deliver the generated signal to the remote piezoelectric transceiver.

3. The device as claimed in claim 1, wherein, the remote module comprising an external communication stage, the measurement stage is configured to command the transmission of a signal containing the measured values via said external communication stage.

4. The device as claimed in claim 1, wherein the control stage comprises a memory area in which is stored a table that is predetermined, for example empirically, and that contains the correspondence between the duty cycle and a range of values of the parameter.

5. An electric machine for a motor vehicle, said electric machine comprising a stator, a rotor, and a device as claimed in claim 1, said electric machine being configured to be mounted in said vehicle in order to drive the wheels of said vehicle to rotate, in which electric machine the main module is mounted on the stator and the remote module is mounted on the rotor.

6. The electric machine as claimed in claim 5, wherein the remote module is mounted inside the rotor.

7. The electric machine as claimed in claim 5, wherein, the rotor comprising a shaft comprising a first shaft portion and a second shaft portion that are mounted on the stator via a system of bearings, the first shaft portion comprising an end face extending orthogonally to the longitudinal axis of rotation of the rotor, the remote piezoelectric transceiver is mounted on said end face and the main piezoelectric transceiver is mounted on a portion of the stator facing said remote piezoelectric transceiver.

8. A battery or battery pack or fuel cell for a motor vehicle, comprising a measuring device as claimed in claim 1, the remote module being mounted such that the sensitive element is placed inside said battery, or inside at least one battery of the battery pack or inside the fuel cell, respectively.

9. A motor vehicle comprising a measuring device as claimed in claim 1.

10. A method for measuring a parameter in a motor vehicle using a measuring device as claimed in claim 1, said method comprising:
commanding, by the control stage, the transmission of an ultrasonic supply signal by the main piezoelectric transceiver,
transmitting, by the main piezoelectric transceiver, said ultrasonic supply signal,
receiving, by the remote piezoelectric transceiver, the transmitted ultrasonic supply signal,
collecting and storing (E4), by the measurement stage the energy of the ultrasonic supply signal,
electrically powering, by the measurement stage, the sensitive element, using the stored energy,
measuring, by the sensitive element, the parameter,
generating, by means of the sensitive element, a measurement signal comprising at least one value of the measured parameter,
transmitting, by the sensitive element, said generated measurement signal to the measurement stage,
receiving, by the measurement stage, the measurement signal,
extracting, by the measurement stage, at least one value of the measured parameter contained in the received measurement signal,
generating, by the measurement stage, a pulse-width modulation signal the duty cycle of which is representative of the at least one value of the extracted measured parameter,
converting, by the remote piezoelectric transceiver, the received pulse-width modulation signal into an ultrasonic measurement signal,
transmitting, by the remote piezoelectric transceiver, said ultrasonic measurement signal to the main piezoelectric transceiver,
determining, by of the control stage, the duty cycle of the received ultrasonic measurement signal,
determining, by the control stage, the at least one value of the measured parameter on the basis of the determined duty cycle.
